(19) United States
(12) Patent Application Publication
(10) Pub. No.: US 2014/0016898 A1
(43) Pub. Date: Jan. 16, 2014

(54) OPTICAL WAVEGUIDE CONNECTOR

(71) Applicant: HON HAI PRECISION INDUSTRY CO., LTD., New Taipei (TW)

(72) Inventors: GENN-SHENG LEE, New Taipei (TW); JIA-HAU LIU, New Taipei (TW)

(21) Appl. No.: 13/942,961

(22) Filed: Jul. 16, 2013

(30) Foreign Application Priority Data
Jul. 16, 2012 (CN) 201210243353.5

(51) Int. Cl. G02B 6/32; G02B 6/26

(52) U.S. Cl. CPC G02B 6/32; G02B 6/26
USPC 385/33; 385/31

(57) ABSTRACT

An optical waveguide connector for transmitting light from a laser emitter and to a photo receiver on a circuit board, including a base section having a receiving passageway; a planar waveguide received in the receiving passageway; and a light guide device coupling to the planar waveguide; wherein the planar waveguide has an input waveguide core corresponding to the laser emitter and an output waveguide core corresponding to the photo receiver; wherein the planar waveguide has a smooth front face, the input waveguide core and the output waveguide core extending to the front face; and wherein the light guide device comprises a first reflector proximal to the front face and a second reflector distal from the front face, the second reflector turns the light from the laser emitter toward the input waveguide core, and the first reflector turns the light from the output waveguide core toward the photo receiver.

### BACKGROUND OF THE INVENTION

1. Field of the Invention

The present invention relates to an optical waveguide connector and particularly to a light guide device.

2. Description of Prior Arts

U.S. Pat. No. 8,335,411 discloses a device for transmitting and reflecting light between a plurality of lenses. The device includes a waveguide, a light emitter, a light detector, a spliting surface, and a reflector. The spliting surface is used to turn light from the emitter toward the waveguide, and is also used to pass light from the waveguide to the refector.

U.S. Pat. No. 8,231,284 discloses a dual-lens optical relay system for coupling light from an optoelectronic (OE) array device to waveguides (built into organic circuit board). First lens are integrated into the backside of the OE device, while second lens are incorporated with the waveguides and turning mirrors fabricated on the organic circuit board. These lenses are designed to provide nearly collimated light therebetween by optimizing lenses radii curvature.

U.S. Patent Application Publication No. 2005/0281507 discloses lenses of individual rows in lens array having both a different focal length and a different lens thickness. U.S. Pat. No. 7,212,698 discloses staggering combined microlens/turning mirror, either as single optical component or as separate optical components, to decrease spacing between waveguides.

It is desired to provide a simple structure for a light guide device that reduces loss of light.

### SUMMARY OF THE INVENTION

An object of the present invention is to provide an opticl waveguide connector, wherein the connector reduce the loss of the light by using different lenses to adjust the optical distance and by positioning the the laser emitter and the photo receiver.

To achieve the above object, the present invention provides an optical waveguide connector for transmitting light from a laser emitter and to a photo receiver on a circuit board, including: a base section having a receiving passageway; a planar waveguide received in the receiving passageway; and a light guide device coupling to the planar waveguide;

wherein the planar waveguide has an input waveguide core corresponding to the laser emitter and an output waveguide core corresponding to the photo receiver, the input waveguide core is adjacent to the output waveguide core in a same plane;

wherein the planar waveguide has a smooth front face, the input waveguide core and the output waveguide core extending to the front face; and
wherein the light guide device comprises a first reflector proximal to the front face and a second reflector distal from the front face, the second reflector turns the light from the laser emitter toward the input waveguide core, and the first reflector turns the light from the output waveguide core toward the photo receiver.

Other objects, advantages and novel features of the invention will become more apparent from the following detailed description of the present embodiment when taken in conjunction with the accompanying drawings.

### BRIEF DESCRIPTION OF THE DRAWING

FIG. 1 is a perspective view of an optical waveguide connector;

FIG. 2 is an exploded view of an optical waveguide connector;

FIG. 3 is another exploded view of the optical waveguide connector as shown in FIG. 2;

FIG. 4 is another perspective view of the optical waveguide connector as shown in FIG. 1; and

FIG. 5 is a cutaway view of an optical waveguide connector.

### DETAILED DESCRIPTION OF THE PREFERRED EMBODIMENT

Reference will now be made to the drawing figures to describe the present invention in detail.

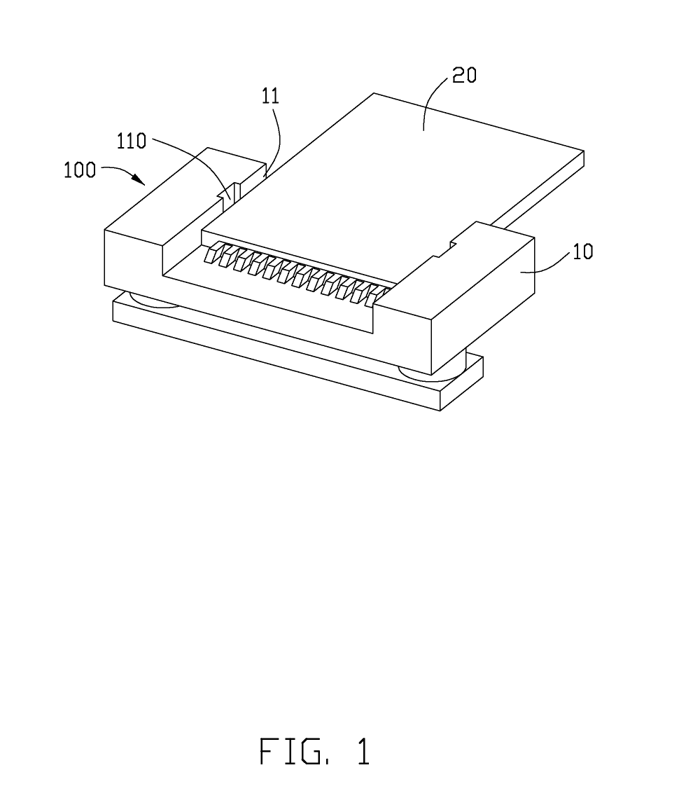

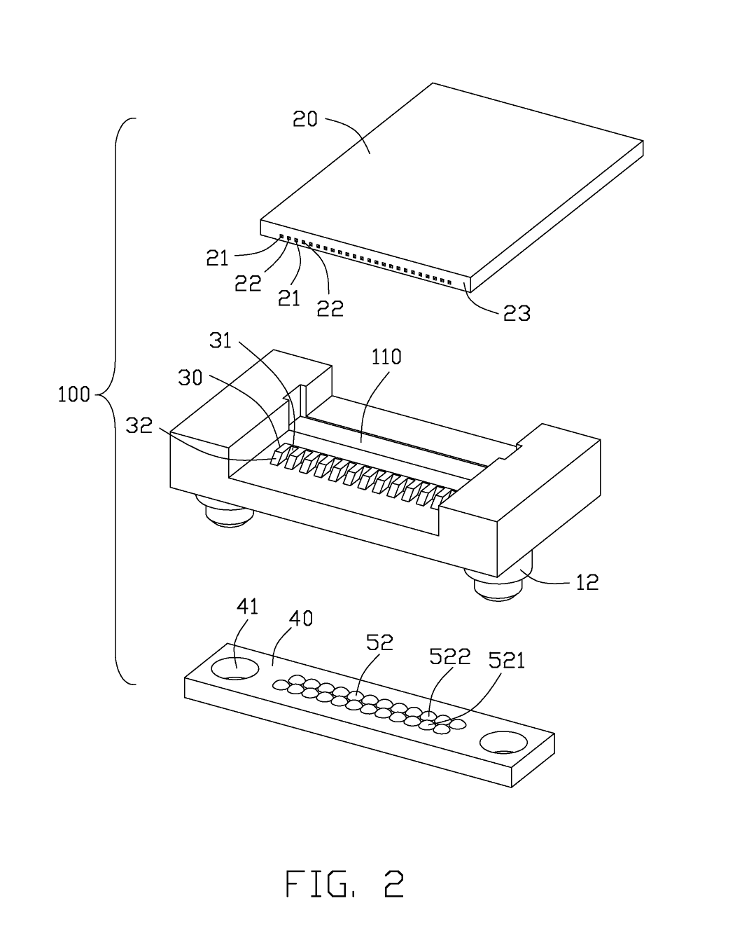

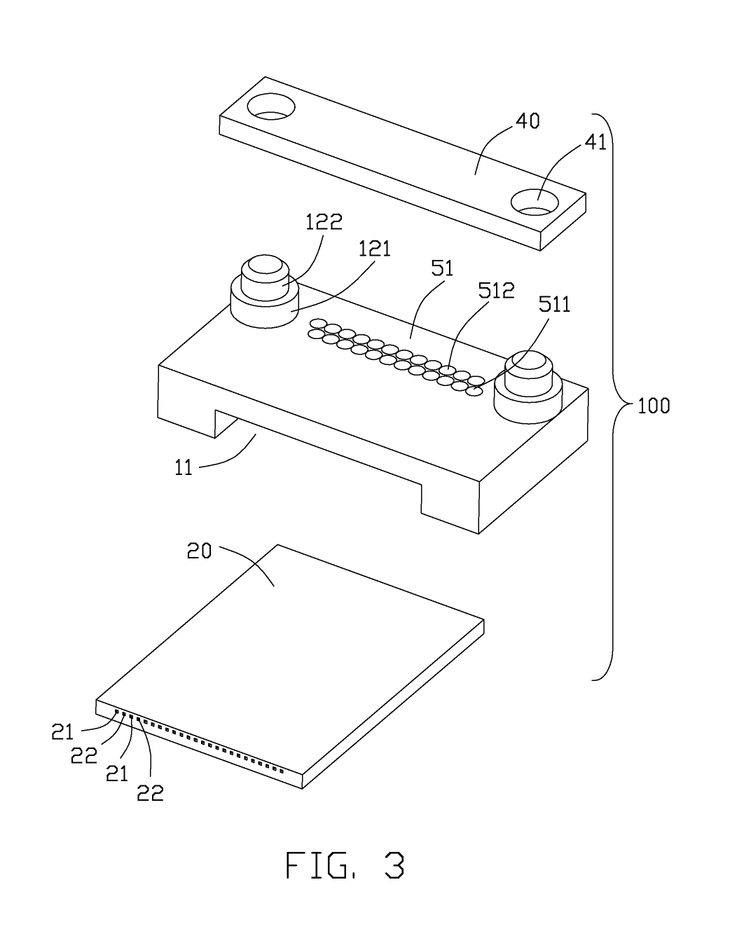

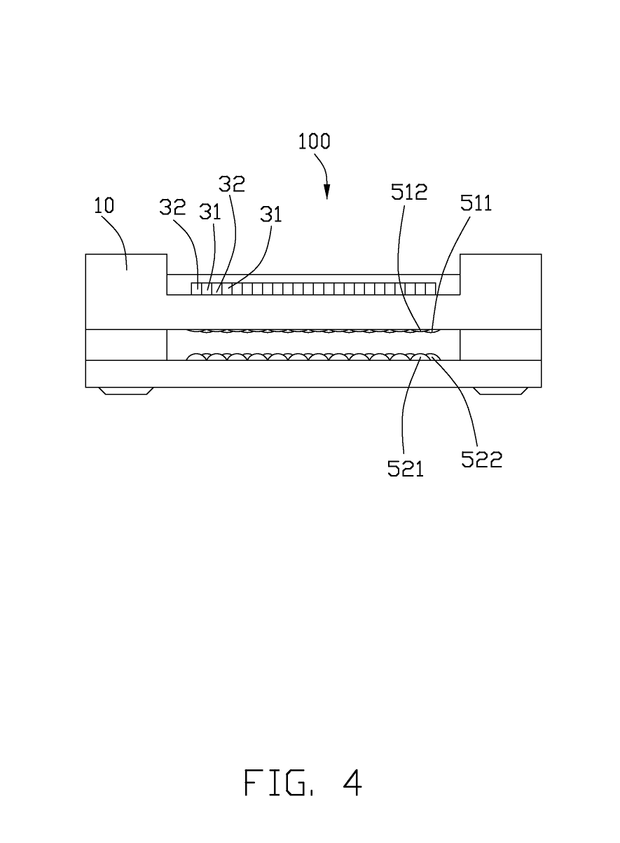

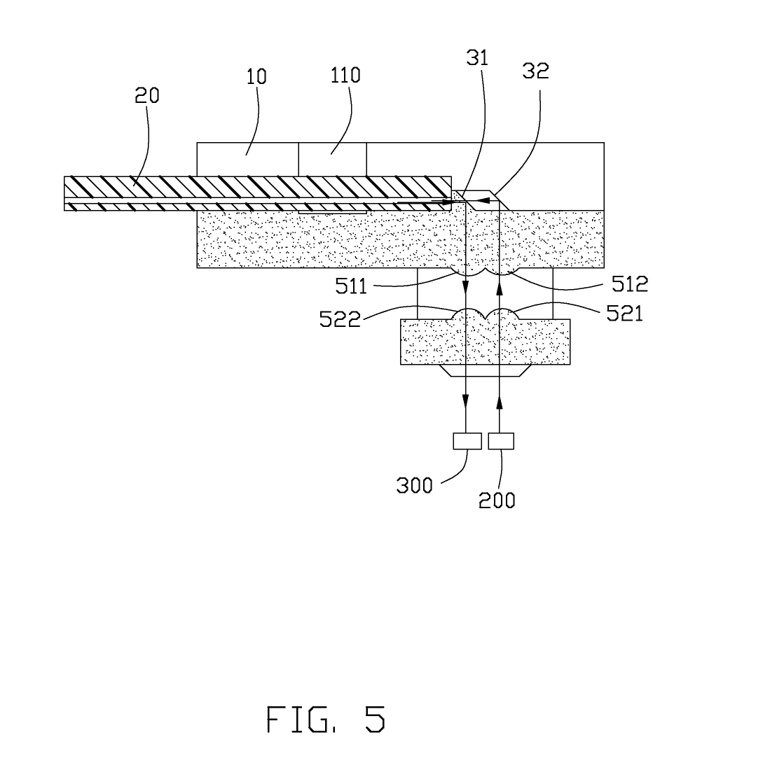

FIGS. 1-5 show an optical waveguide connector 100 for transmitting light from a laser emitter 200 and to a laser transcevier 300 on a circuit board. The optical waveguide connector 100 includes a base section 10 having a receiving passageway 11, a planar waveguide 20 received in the receiving passageway 11, and a light guide device 30 which couples to the planar waveguide 20 received in the receiving passageway 11. There is a groove 110 in the receiving passageway 11 for gluing the planar waveguide 20 to retain the planar waveguide 20 in the receiving passageway 11. The planar waveguide 20 includes a number of input waveguide cores 21 crroesponding to the laser emitter 200 and a number of output waveguide cores 22 corresponding to the photo receiver 300, each input waveguide core 21 being adjacent to a output waveguide 22 core on a same plane.

The planar waveguide 20 has a smooth front face 23. The input waveguide cores 21 and the output waveguide cores 22 extend to the front face 23. The front face 23 of the planar waveguide 20 closely fit the light guide device 30 to make the light transport with minimal loss. The light guide device 30 includes a number of first reflectors 31 proximal to the front face 23 and a number of second reflectors 32 distal from the front face 23. Because of the aperture of the laser emitter 200 is designed to be smaller than the aperture of the input or output waveguide cores 21, 22 and the aperture of the input or output waveguide cores 21, 22 is designed to be smaller than the aperture of the photo receiver 300, the laser emitter 200 is arranged closer to the planar waveguide 20 than the photo receiver 300 is in the horizontal direction. The light from small apertures of the output waveguide cores 22 enters the photo receiver 300 having a large aperture relative to the output waveguide 22, and the other light from a small aperture of the laser emitter 200 enters the input waveguide cores 21 having a large aperture relative to the laser emitter 200. This arrangement reduces the loss of the light in the transmission.

The first reflectors 31 and the second reflectors 32 are formed on the base section 10. The first reflectors 31, the second reflectors 32, and the base section 10 are integrated as a single optical component using suitable light transparent material. Each of the first reflectors 31 and the second reflectors 32 forms a 45 degree angle relative to a direction along which the planar waveguide 20 extends.

The bottom face of the base section 10 has a cylindrical post 12. The post 12 includes a first part 121 extending from the bottom and a second part 122 extending from the first part 121, the diamater of the first part 121 being larger than the diamater of the second part 122. The optical waveguide connector 100 also includes dual lens assembly in the lower part of the base section 10 and a base plate 40 fixed at the post 12. The base plate 40 defines a mounting hole 41. A diamater of the mounting hole 41 is smaller than the diamater of the first part 121. Therefore, when the base plate 40 mounts at the post 12, the mounting hole 41 is retained at the second part 122 of the post 12. There is a space for receiving the dual lens assembly between the base plate 40 and the bottom of the base section 10.

The dual lens assembly includes an upper lens device 51 on the bottom face of the base section 10 and a lower lens device 52 on the base plate 40 corresponding to the upper lens device 51. The upper lens device 51 and the base section 10 are uniformed with the same material too. The lower lens device 52 and the base plate 40 are integrally formed with same material. The upper lens device 51 includes a number of first lenses 511 and a number of second lenses 512. The lower lens device 52 includes a number of third lenses 521 and a number of fourth lenses 522. The light forwardly and dispersively coming out from the output waveguide cores 22 is firstly reflected by the first reflectors 31 downwardly, and secondly turned to parallel light by the first lenses 511, and thirdly focused by the fourth lenses 522 to the photo receiver 300, while the light upwardly and dispersively coming out from the laser emitter 200 is firstly turned to parallel light by the third lenses 521, and secondly further focused by the second lenses 512, and thirdly reflected by the second reflectors 32 to the input waveguide cores 21.

A focal distance of the second lenses 512 is longer than a focal distance of the first lenses 511.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An optical waveguide connector for transmitting light from a laser emitter and to a photo receiver on a circuit board, comprising:
a base section having a receiving passageway; a planar waveguide received in the receiving passageway; and a light guide device coupling to the planar waveguide;
wherein the planar waveguide has an input waveguide core corresponding to the laser emitter and an output waveguide core corresponding to the photo receiver, the input waveguide core is adjacent to the output waveguide core in a same plane;
wherein the planar waveguide has a smooth front face, the input waveguide core and the output waveguide core extending to the front face; and
wherein the light guide device comprises a first reflector proximal to the front face and a second reflector distal from the front face, the second reflector turns the light from the laser emitter toward the input waveguide core, and the first reflector turns the light from the output waveguide core toward the photo receiver.

2. The optical waveguide connector as claimed in claim 1, wherein the first reflector and the second reflector are formed as a single piece with the base section.

3. The optical waveguide connector as claimed in claim 1, wherein each of the first reflector and the second reflector forms a 45 degree angle relative to a direction along which the planar waveguide extends.

4. The optical waveguide connector as claimed in claim 1, further comprising an upper lens device including a first lens and a second lens and a lower lens device including a third lens and a fourth lens, and wherein the light from the output waveguide core is firstly reflected by the first reflector downwardly, and secondly turned to parallel light by the first lens, and thirdly focused by the fourth lens to the photo receiver, while the light from the laser emitter is firstly turned to parallel light by the third lens, and secondly further focused by the second lens, and thirdly reflected by the second reflector to the input waveguide core.

5. The optical waveguide connector as claimed in claim 4, wherein a focal distance of the second lens is longer than a focal distance of the first lens.

6. The optical waveguide connector as claimed in claim 5, further comprising a base plate arranged below the base section, and wherein the upper lens device is arranged on the bottom face of the base section and the lower lens device is arranged on the base plate.

7. The optical waveguide connector as claimed in claim 5, wherein the base section has a post and the base plate has a mounting hole receiving the post.

8. An optical waveguide connector assembly comprising:
a base section equipped with a plurality of first reflectors in a first row and a plurality of second reflectors in a second row, said first row and said second row beign space from each other in a front-to-back direction and at a same level in a vertical direction perpendicular to said front-to-back direction while each extending along a transveres direction perpendicular to both said front-to-back direction and said vertical direction;
a waveguide positioned upon the base section and defining a plurality of input waveguide cores and a plurality of output waveguide cores alternate arranged with each other in a same row at said same level, and aligned with the corresponding first reflectors and second reflectors, respectively in said front-to-back direction; and
a lens device defining a plurality of lenses alternately arranged in two rows to be aligned, in the vertical direction, with the corresponding first reflectors and second reflectors, respectively; wherein
a first light coming from the lens and reflected by the corresponding second reflector, enters the corresponding input waveguide core; a second light coming from the output waveguide core and reflected by the corresponding first reflector, enters the corresponding lens.

9. The optical waveguide connector assembly as claimed in claim 8, wherein a photo receiver and a laser emitter disposed under the lens device opposite to both said first reflectors and said second reflectors in the vertical direction, and the first light comes from the laser emitter while the second light enters into the photo receiver.

10. The optical waveguide connector assembly as claimed in claim 8, wherein the neighboring lenses are overlapped with each other in the front-to-back direction while the neighboring first and second reflectors are not.
